(19) United States
(12) Patent Application Publication
(10) Pub. No.: US 2025/0278478 A1
(43) Pub. Date: Sep. 4, 2025

(54) Double Subscription Service & Reactive Event Notification Loop

(71) Applicant: CrowdStrike, Inc., Sunnyvale, CA (US)

(72) Inventors: Hazim Avdal, Cincinnati, OH (US); Aleksandr Markenzon, Arlington, VA (US); Samhitha Tarra, New York, NY (US); Victor East Truong, Monterey Park, CA (US)

(21) Appl. No.: 18/593,741

(22) Filed: Mar. 1, 2024

(51) Int. Cl. G06F 21/55

(52) U.S. Cl. CPC G06F 21/554; G06F 2221/034

(57) ABSTRACT

A hierarchical subscription-publication service distributes an event notification. The event notification is associated with a database. The event notification is also associated to a graph having nodes and to a subgroup of the nodes. A first subscription service publishes the event notification to all subscribers associated with the database. A second or intermediary subscription service hierarchically nests within the outer subscription service and publishes the event notification to a subscriber subgroup of the subscribers associated with the subgroup of the nodes.

### BACKGROUND

The subject matter described herein generally relates to computers and to computer databases and, more particularly, the subject matter relates to graph-based publish and subscribe models.

Publish-Subscribe (or Pub-Sub) messaging models relay messages from publishers to subscribers. Pub-Sub messaging models have been applied to application graphs, where graph-based subscribers (e.g., subscription nodes and edges) are matched to graph-based publishers (e.g., content nodes and edges). When a graphical node or edge changes, change notifications are dispersed to the graph-based Pub-Sub messaging model for distribution to the appropriate node/edge subscribers.

### SUMMARY

A hierarchical double subscription service distributes an event notification. The event notification is associated with a database. The event notification is also associated to a graph having vertices and edges and to a subgroup of the vertices and edges. A first or outer subscription service publishes the event notification to subscribers associated with the database. A second or intermediary subscription service hierarchically nests within the outer subscription service and publishes the event notification to a subscriber subgroup of the subscribers. The subscriber subgroup registers its interest in the subgroup of the vertices and edges. The double subscription service may implement a reactive notification loop that recursively updates the database and the subscriber subgroup.

### BRIEF DESCRIPTION OF THE SEVERAL VIEWS OF THE DRAWINGS

The features, aspects, and advantages of the double subscription service and the reactive notification loop are understood when the following Detailed Description is read with reference to the accompanying drawings, wherein:

FIGS. 1-5 illustrate examples of an architecture for a reactive event notification loop;

FIG. 6 illustrates more detailed examples;

FIGS. 7-9 illustrate examples of constraints;

FIGS. 10-11 illustrate still more detailed examples of the reactive event notification loop;

FIG. 12 illustrates a flowchart or method for publishing a cybersecurity event notification;

FIG. 13 illustrates more examples of a flowchart or method for publishing the event notification;

FIG. 14 illustrates still more examples of a flowchart or method for publishing the event notification;

FIG. 15 illustrates examples of a flowchart or method for publishing the cybersecurity event notification; and

FIG. 16 illustrates a more detailed example of an operating environment.

### DETAILED DESCRIPTION

Some examples relate to subscription services for graph databases. A database stores data, and the database is often represented as a table having rows and columns. The database, though, may also be represented as a graph. The graph has nodes and edges. Data stored in the database may be represented as a node and/or edge in the graph. An edge connects adjacent nodes, and the edge represents a relationship between the adjacent nodes. Large databases are thus often easier to visualize and to understand as a graph database.

The graph database, though, may be difficult to update. When a piece of data changes, the change in that data may also change the graph. When the graph changes, a computer is programmed to notify of the change to the graph. A large graph (representing a large database) may thus frequently change with data changes. Large graphs, in fact, may emit change notifications at a massive scale (perhaps millions or trillions per day). Conventional publication-subscription messaging models, though, have great difficulty ingesting such massive amounts of change notifications. Each graphical change, for example, requires that computers consume much memory and processor resources. The change notifications thus also clog and delay communications networks. Conventional publication-subscription messaging models thus bog down computer and network performance and further consume much electrical power.

Some examples of a double subscription service elegantly improve computer performance. The double subscription service may only notify subscribers when particular portions of the graph change. Subscribers, for example, may register a particular interest in specific nodes, edges, and/or subgraphs within the graph. The double subscription service then monitors the graph for changes to those specific nodes, edges, and/or subgraphs. When the double subscription service determines that any of those specific portions of the graph have changed, then the double subscription service may notify only those subscribers who care. The double subscription service, in other words, may only notify those subscribers have subscribed to those specific portions. The double subscription service, in other words, may only notify those subscribers that registered their interest in the specific nodes, edges, and/or subgraphs. The double subscription service thus substantially reduces the number of notifications that are processed and sent. Even though the graph may undergo millions or trillions of changes per day, the double subscription service only alerts those subscribers who care about specific changes to the graph. The double subscription service greatly reduces the amount of computer software and hardware resources that are consumed. The double subscription service greatly reduces electrical power consumed by computer software and hardware resources. The double subscription service also greatly reduces packet traffic within communications networks.

Some examples of the double subscription service further improve computer performance. The double subscription service may implement a reactive notification loop that enables recursive updates to cloud services. The double subscription service may notify a downstream service when an upstream service has changed. By alerting the downstream service, the downstream service may react and change in response to the upstream change. The double subscription service, however, may also then notify the upstream service of the change in the downstream service. By alerting the upstream service, the upstream service may, in turn, react and change in response to the downstream change. This cyclic reactive notification loop may continue updating-and-reacting, thus allowing continuous refinement of the upstream/downstream cloud services. The reactive notification loop thus continually improves the functioning of computers that provide the upstream and downstream cloud services.

Double subscription and reactive notification looping will now be described more fully hereinafter with reference to the accompanying drawings. Double subscription and reactive notification looping, however, may be embodied in many different forms and should not be construed as limited to the examples set forth herein. These examples are provided so that this disclosure will be thorough and complete and fully convey Double subscription and reactive notification looping to those of ordinary skill in the art. Moreover, all the examples of Double subscription and reactive notification looping are intended to encompass both structural and functional equivalents thereof. Additionally, it is intended that such equivalents include both currently known equivalents as well as equivalents developed in the future (i.e., any elements developed that perform the same function, regardless of structure).

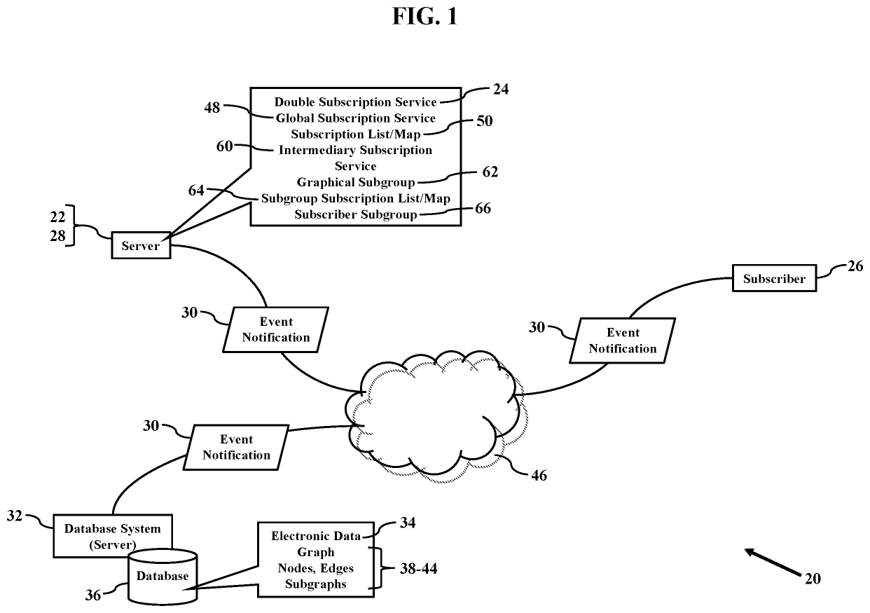

FIGS. 1-5 illustrate examples of an architecture for a reactive event notification loop 20. A computer system 22 provides a double subscription service 24 that alerts one or more subscribers 26. FIG. 1 illustrates the computer system 22 as a server 28, but computer system 22 may be any processor-controlled device (as later paragraphs will explain). The server 28 receives an event notification 30 from a database system 32. The database system 32 stores electronic data 34 in a database 36, and the database system 32 may represent the electronic data 34 stored in the database 36 as a graph 38 having nodes 40, edges 42, and subgraphs 44. When the database system 32 updates or changes the electronic data 34, the database 36, and/or the graph 38, then the database system 32 sends the event notification 30 via a communications network 46 to the network/IP address associated with the server 28. The event notification 30 describes or references the updates/changes made to the electronic data 34 stored to the database 36. The event notification 30, for example, may specify the corresponding nodes 40, edges 42, and/or subgraphs 44 that changed due to the updates/changes to the graph 38.

The server 28 determines the subscriber(s) 26 that should be alerted. When the server 28 receives the event notification 30, the server 28 provides the double subscription service 24 that publishes or distributes the event notification 30 to the subscribers 26. The server 28, for example, may first determine what parties, customers, or services are notified of global changes to the graph 38. The server 28, for example, may initially provide a global or outer subscription service 48 that publishes most or all changes to the graph 38. The global or outer subscription service 48, in other words, may subscribe to all the graphical nodes (or vertices) 38, edges 42, and/or subgraphs 44 associated with the graph 38. Because the server 28 subscribes to all updates/changes to the graph 38, the database system 32 may update or alert the server 28 of any, each, and/or every change associated with the graph 38. The server 28 may then provide the global or outer subscription service 48 that distributes or publishes the event notification 30 to none, any, or all the subscribers 26 associated with the graph 38. The server 28, for example, identifies a graph subscription list 50 that maps the node/edge/subgraph 38/40/42 portions of the graph 38 to the subscribers 26 and their corresponding network or IP addresses. The global or outer subscription service 48 may then forward or publish the event notification 30 to the subscribers 26 registering their subscriptive interest in the entire graph 38. The global or outer subscription service 48 thus asynchronously alerts those subscribers 26 expressing their interest in graphical changes to the graph 38. Some subscribers 26, in other words, may subscribe to all changes to the graph 38, without regard to specific node/edge/subgraph 38/40/42 portions. The global or outer subscription service 48, however, may notify no or zero subscribers (such as when no subscribers subscribe to global changes to the graph 38).

The server 28, however, may also provide a second, and more specific, publication. The server 28, for example, may also provide an intermediary subscription service 60. The intermediary subscription service 60 may be hierarchically nested within the reactive event notification loop 20 and/or within the outer subscription service 48. The intermediary subscription service 60 may thus be a sub-service offering within the reactive event notification loop 20 and/or within the outer subscription service 48. The intermediary subscription service 60, though, may only alert or notify privileged or permissioned subscribers 26 that register with, and/or that subscribe to, the intermediary subscription service 60. The intermediary subscription service 60, however, may only subscribe to specific nodes/edges/subgraphs 40/42/44 associated with the graph 38. The intermediary subscription service 60, for example, registers a subscription to a graphical subgroup 62 of the graphical nodes/edges/subgraphs 40/42/44 associated with the graph 38. The graphical subgroup 62 specifies or identifies specific subscriptive nodes/edges/subgraphs 40/42/44 that is/are monitored by the intermediary subscription service 60. When the server 28 receives the event notification 30, the server 28 may then compare the event notification 30 to the graphical subgroup 62 associated with the intermediary subscription service 60. That is, the server 28 may compare the nodes/edges/subgraphs 40/42/44 referenced by the event notification 30 to the graphical subgroup 62 associated with the intermediary subscription service 60. If any one or more of the nodes/edges/subgraphs 40/42/44 referenced by the event notification 30 match or equal the graphical subgroup 62, then the server 28 may provide the intermediary subscription service 60. The server 28, for example, may identify a subgroup subscription list/map 64 that identifies a subscriber subgroup 66 of the subscribers 26 that are notified of specific nodal/edge/subgraph changes to the graph 38. Once the subscriber subgroup 66 is identified, the server 28 may then forward or publish the event notification 30 to the subscriber subgroup 66 and their corresponding network or IP addresses. The intermediary subscription service 60 thus listens or monitors for changes to the nodes/edges/subgraphs 40/42/44 of interest to the subscriber subgroup 66. The intermediary subscription service 60 then asynchronously alerts the subscriber subgroup 66 that their specific nodal/edge/subgraph portion of the graph 38 has changed.

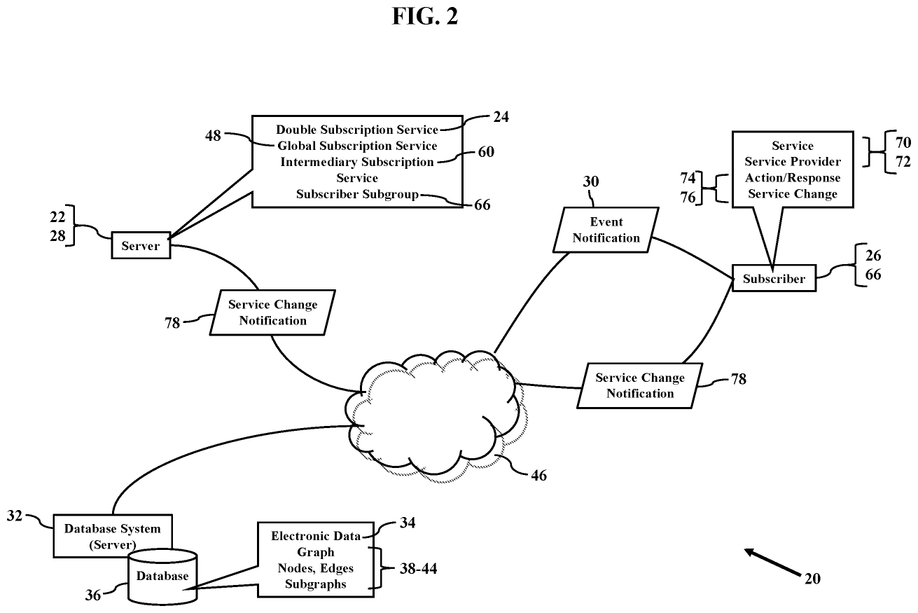

As FIG. 2 illustrates, the distributed, the double subscription service 24 reacts to database changes. The server 28 listens for changes to the nodes/edges/subgraphs 40/42/44 of interest to the subscriber subgroup 66. That is, the intermediary subscription service 60 monitors for the event notification(s) 30 that is/are of interest to the subscriber subgroup 66 (e.g., the subscriptive nodes/edges/subgraphs 40/42/44 associated with the graph 38). The intermediary subscription service 60, in other words, listens for specific graphical relations/dispositions (e.g., referenced by the event notification 30) from the upstream database system 32. If the intermediary subscription service 60 determines that the event notification 30 describes or references the subscriptive nodes/edges/subgraphs 40/42/44 associated with the subscriber subgroup 66, then the intermediary subscription service 60 alerts the appropriate subscriber(s) 26. The intermediary subscription service 60, for example, sends or forwards the event notification 30 to the network/IP addresses mapped to the subscriptive nodes/edges/subgraphs 40/42/44.

The subscriber 26 may then react to the event notification 30. The subscriber 26 (such as a member of the subscriber subgroup 66) provides a function, routine, or other service 70. The subscriber 26/66, for example, may be an internal service provider 72 that is affiliated with the database system 32 and/or with the double subscription service 24. The service provider 72, as another example, may be a cloud service that provides either or both of the database system 32 and/or the double subscription service 24. The subscriber 26/66, as yet another example, may be an external service provider 72 that is unaffiliated with the database system 32 and/or the double subscription service 24 (and/or with a cloud service). Whatever the subscriber 26 and/or the service 70, when the subscriber 26 receives the event notification 30, the subscriber 26 is alerted to the nodal/edge/subgraph change in the graph 38 (as referenced by the event notification 30). The subscriber 26 may thus change or modify its external service 70 in response to the event notification 30 sent by the intermediary subscription service 60. The event notification 30, in other words, triggers an action or response 74 (such as a service change 76) at and/or by the subscriber 26/66.

As FIG. 2 further illustrates, the external subscriber 26 may then alert the intermediary subscription service 60. When a subscriber 26 (such as any member of the subscriber subgroup 66) changes or modifies its service 70 (such as in response to the event notification 30), the subscriber 26 may notify the intermediary subscription service 60 of the external service change 76. The external subscriber 26, for example, may generate and send a service change notification 78 to the intermediary subscription service 60. While the service change notification 78 may be sent to any network or IP address associated with the intermediary subscription service 60, for simplicity, FIG. 2 illustrates the server 28. The external subscriber 26 sends the service change notification 78 to the network or IP address associated with the server 28. The service change notification 78 describes or references the external service change 76 implemented by the external service 70 (such as in response to the event notification 30 referencing the recent nodal/edge/subgraph change in the graph 38).

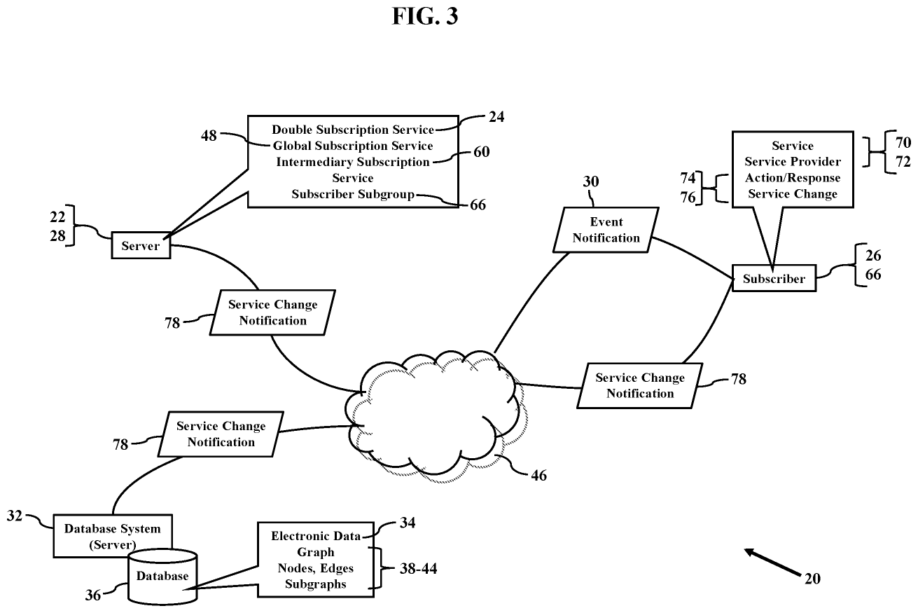

As FIG. 3 illustrates, the intermediary subscription service 60 may then react to the service change notification 78. Because the internal or external service 70 has changed (perhaps in response to the event notification 30), the intermediary subscription service 60 may itself change, adapt, or respond to the service change 76. As a simple example, when the server 28 receives the service change notification 78 (describing or referencing the service change 76 implemented by the service 70), the server 28 may be programmed to alert the upstream database system 32. The server 28, for example, may forward the service change notification 78 to the network or IP address associated with the database system 32. The server 28, though, may generate and send another message or alert to the database system 32. The intermediary subscription service 60 thus notifies the database system 32 that the service 70 changed or modified (perhaps in response to the recent nodal/edge/subgraph change in the graph 38).

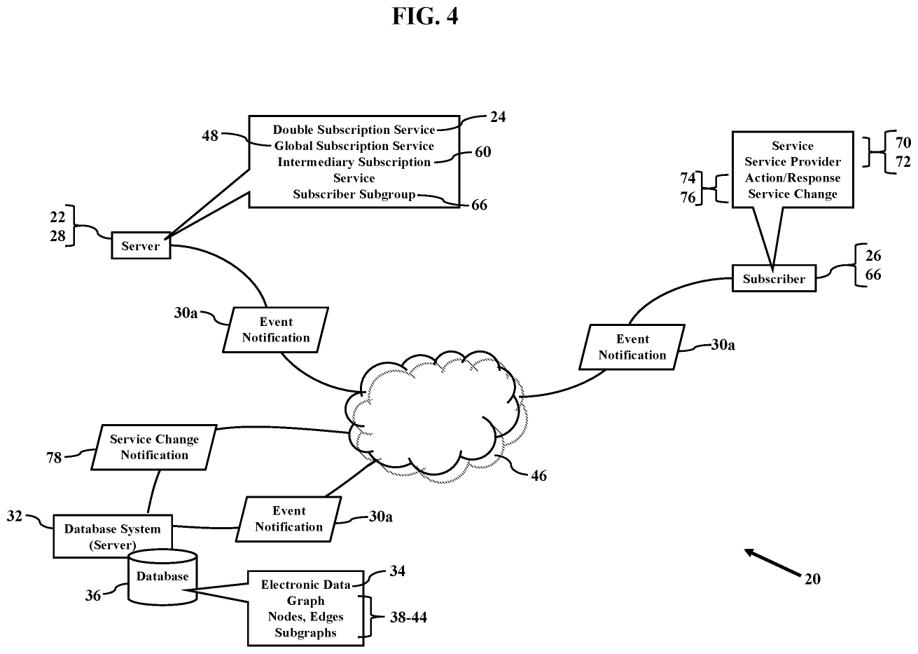

As FIG. 4 illustrates, the database system 32 may then react to the service change 76. When the database system 32 receives the service change notification 78, the service change notification 78 alerts the database system 32 to the service change 76 implemented by the service 70. The service change notification 78 may thus drive or cause another update or change in the electronic data 34 stored to the database 36. The database system 32, in other words, may modify the nodes/edges/subgraphs 40/42/44 of the graph 38, in response to the service change 76 implemented by the service 70. Recall, however, that when the nodes/edges/subgraphs 40/42/44 change, the database system 32 may generate and send another event notification (illustrated as reference numeral 30a) to the server 28. This subsequent event notification 30a again describes or references the latest updates/changes to the graph 38 associated with the database 36. When the server 28 receives the event notification 30a, the server 28 again provides the double subscription service 24. The server 28, for example, may provide the global or outer subscription service 48 that distributes or publishes the event notification 30a to all the subscribers 26 associated with the graph 38. The server 28, however, may also provide the intermediary subscription service 60 (hierarchically nested within the outer subscription service 48) that distributes or publishes the event notification 30a to the subscriber subgroup 66 that subscribes to the specific nodes/edges/subgraphs 40/42/44 of interest.

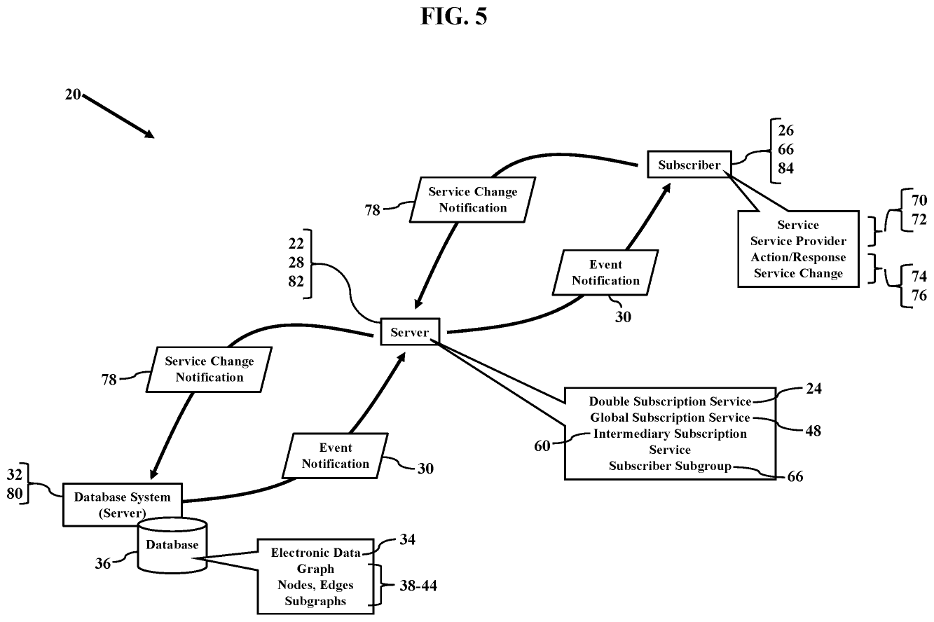

FIG. 5 thus illustrates more examples of the reactive event notification loop 20. The reactive event notification loop 20 may reference a systematic or architectural starting point 80 (such as, for example, the database system 32 implementing the graph 38 representing the database 36). When the graph 38 changes, the database system 32 issues the event notification 30. The reactive event notification loop 20 may reference a systematic or architectural intermediate point 82 (such as the server 28 or any other processor-controlled device) providing at least a portion of the double subscription service 24. The global or outer subscription service 48, for example, may anonymously publish the event notification 30 to all the subscribers 26 associated with the graph 38. The nested, intermediary subscription service 60, however, additionally or alternatively distributes or publishes the event notification 30 to the subscriber subgroup 66 that subscribes to the portion (e.g., the specific nodes/edges/subgraphs 40/42/44) of the graph 38 that changed. The reactive event notification loop 20 may reference a systematic or architectural terminus, loopal, or end point 84 at the subscriber/service 26/70 that implements the service change 76 in response to the change in the graph 38. The reactive event notification loop 20 may then return back to the systematic or architectural intermediate point 82 (such as the server 28) that receives the service change notification 78 (describing or referencing the service change 76 implemented by the service 70). The reactive event notification loop 20 may then continue back to the systematic or architectural starting point 80 at the database system 32 that receives the service change notification 78 alerting to the service change 76 implemented by the external service 70. The nested, intermediary subscription service 60 thus acts as a middleman service or middleware broker between the input database system 32 and the output subscriber/service 26/70. The nested, intermediary subscription service 60 implements the reactive event notification loop 20 that allows the database system 32 and the output subscriber/service 26/70 to circuitously update the database/graph 36/38 as a double-feedback mechanism.

The reactive event notification loop 20 thus implements the double subscription service 24. The reactive event notification loop 20 may cyclically react to upstream changes in the graph 38 and to downstream changes in the service 70. The nested, intermediary subscription service 60 listens for nodal/edge/subgraph changes to the graph 38 and notifies the subscriber subgroup 66 (such as the internal/external service 70) subscribing to the nodal/edge/subgraph portion of the graph 38 that changed. The nested, intermediary subscription service 60 may thus intercept and publish the event notification 30 to trigger further changes to the graph 38. The double subscription service 24. for example, may thus represent or implement a double publication-subscription model (or 2×pub-sub) that recursively modifies the graph 38 and/or the database 36. The reactive event notification loop 20 allows the intermediary subscription service 60 to listen, update, and make even more updates based on nodal/edge subscriptions. The reactive event notification loop 20 may thus be circular and keep going and updating as many times as desired. The reactive event notification loop 20 thus creates and enables a continuous flow of updates, mutations, and notifications. The distributed, asynchronous reactive event notification loop 20 alerts or notifies of changes to both the database system 32 and to the subscriptive service 70.

The double subscription service 24 provides two (2) notification systems. The global or outer subscription service 48, for example, receives the event notification 30 of any and all changes to the graph 38. Because the global or outer subscription service 48 may subscribe to all the nodes/edges/subgraphs 40/42/44 associated with the graph 38, the global or outer subscription service 48 receives notice of all nodal/edge/subgraph changes. The nested, intermediary subscription service 60, however, is subscription-based. The nested, intermediary subscription service 60 may only notify the subscriber subgroup 66 that cares to listen. The reactive event notification loop 20 thus issues alerts from both the database system 32 and from the service 70.

The nested, intermediary subscription service 60 implements need-based updates. Because the database 36 may store and track a very large pool of data items and relationships, the database 36 may be very large in rows and/or columns (and thus byte size). The database system 32, then, may issue hundreds, thousands, millions, or even billions of the event notifications 30 on an hourly or daily basis. Conventional database schemes, however, are time-based and only update according to intervals (e.g., every 15 minutes) and/or according to time stamps. The nested, intermediary subscription service 60, however, is time independent and only listens for certain subscriptive types of event notifications 30 (e.g., specified nodes/edges/subgraphs 40/42/44) from the huge pool of all event notifications 32 issued by the database system 32. The nested, intermediary subscription service 60 only causes updates based on need (such as the interested subscriber subgroup 66). The global or outer subscription service 48 may subscribe to all the nodes/edges/subgraphs 40/42/44, whereas the nested, intermediary subscription service 60 targets very specific nodes/edges/subgraphs 40/42/44.

The double subscription service 24 may be anonymous. The double subscription service 24 may function as an intermediary party between the database system 32 (e.g., database service provider) and the subscribers/services 26/66/70 (such as the service provider 72). A database service provider of the database system 32, for example, may have no communicative contact with the subscribers/services 26/70. Indeed, the database service provider may have no knowledge of the subscribers/services 26/70. The database system 32 may merely send or publish the event notification 30 to the double subscription service 24, and the event notification 30 may be destination anonymous (other than the IP address associated with the server 28 providing the double subscription service 24). The identities and/or IP addresses of the subscribers/services 26/70 may remain unspecified and anonymous to the database system 32. Only the double subscription service 24 may thus have access to the subscribers 26 associated with the graph 38 and to the subscriber subgroup 66 and their particular nodes 40, edges 42, and/or subgraphs 44 of interest. The double subscription service 24 may thus remove identifying usernames, service identifiers, network addresses, or other information from packets of data representing the event notification 30 and/or the service change notification 78.

The double subscription service 24 may have different pools of the subscribers 26. The outer subscription service 48, for example, may alert the subscribers 26 who register their interest/subscription to the entire graph 38. The nested, intermediary subscription service 60, though, may only be provided to the subscriber subgroup 66 of the subscribers 26. The nested, intermediary subscription service 60 allows the subscriber subgroup 66 to receive the alert notification 30 of specific graphical changes (e.g., node/edge/subgraph 40/42/44) within the graph 38. The nested, intermediary subscription service 60, however, also allows the subscriber subgroup 66 to recursively update the database/graph 36/38 via service feedback (such as the service change notification 78 and the reactive event notification loop 20). The intermediary subscription service 60 may thus be a nested, sub-service within the double subscription service 24 and/or within the outer subscription service 48. The double subscription service 24, and thus the intermediary subscription service 60, may only be available to the subscribers 26 of the outer subscription service 48.

The reactive event notification loop 20 may have a local or remote component. FIG. 5, for example, illustrates the reactive event notification loop 20 as distributed among/between different services and networked components. The reactive event notification loop 20, for example, may be distributed between or from the database system 32 (providing a graph database service) to the server 28 (providing the double subscription service 24) to the subscriber/service 26/70 that implements the service change 76 in response to the change in the graph 38. The reactive event notification loop 20 may thus be distributed among the communications network 46 (such as a cloud computing environment) and among networked computer systems. The reactive event notification loop 20, however, may also be implemented as a combination or package of services provided by a single networked component. The computer system 22, for example, may receive the event notification 30 from the database system 32 and provide/send the event notification 30 (perhaps after anonymization) to the subscriber/service 26/70. The computer system 22 may then receive and forward/send the service change notification 78 (describing or referencing the service change 76 implemented by the service 70) (perhaps after anonymization) to the database system 32. Indeed, the middleperson computer system 22 may be affiliated with both the database system 32 and the subscriber/service 26/70 (such as permissive access to a cloud service environment that manages/provides both the database system 32 and the service 70). The reactive event notification loop 20 may thus be a single entity service(s) offering.

The reactive event notification loop 20 is asynchronous. While the reactive event notification loop 20 may be provided with near real time processing and networking capabilities, the triggering event notification 30 and/or the service change notification 78 are issued and/or processed in response to updates to the graph 38 and/or the service 70. The reactive event notification loop 20, in other words, is likely initiated after graph/service 38/70 updates have already been initiated (and perhaps successfully completed). The reactive event notification loop 20 may thus be asynchronous, even if only delayed by fractions of a second or other near-real time chronology.

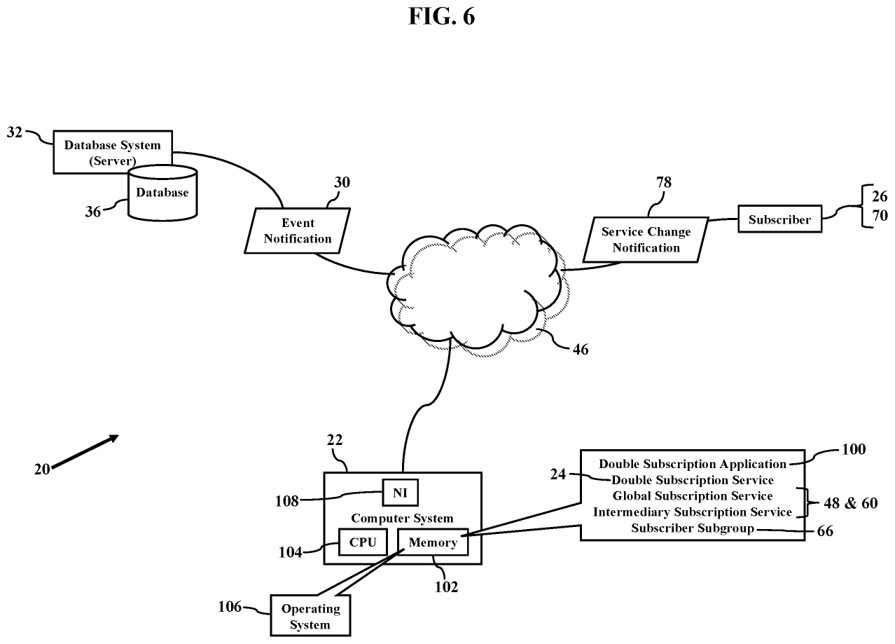

FIG. 6 illustrates more detailed examples of the computer system 22. The computer system 22 provides the double subscription service 24 that alerts the subscriber/service 26/70. The computer system 22 stores a double subscription application 100 in a memory device 102, and a hardware processor 104 executes the double subscription application 100. The computer system 22 also stores and executes an operating system 106. When the computer system 22 receives electrical power (e.g., current/voltage) from a power supply (not shown for simplicity), the operating system 106 boots and manages all the hardware and software resources available to the computer system 22. The operating system 106, for example, manages or controls a network interface (or NIC) 108 to the communications network 46, thus providing the computer system 22 with two-way communications capabilities with the database system 32 and with the subscriber/service 26/70. The double subscription application 100 may thus cooperate with the operating system 106 to provide the double subscription service 24. The double subscription application 100 may thus be computer programming, instructions, or code that cause or instruct the hardware processor 104 and/or the memory device 102 (e.g., the computer system 22) to perform operations, such as receiving and processing the event notification 30 associated with the database system 32. The double subscription application 100 further causes or instructs the hardware processor 104 to perform operations for providing the global or outer subscription service 48 that distributes or publishes the event notification 30 to most or all the subscribers 26 associated with the graph 38 (as explained with reference to FIGS. 1-5). The double subscription application 100 may further cause or instruct the hardware processor 104 to perform operations for providing the intermediary subscription service 60 that forwards or publishes the event notification 30 to the subscriber subgroup 66 (as explained with reference to FIGS. 1-5). The double subscription application 100 thus asynchronously alerts the subscriber subgroup 66 that their specific portion of the graph 38 has changed.

The double subscription application 100 may also cause additional operations. When the subscriber 26/66 changes or modifies its service 70, the double subscription application 100 further causes or instructs the hardware processor 104 to perform operations for receiving the service change notification 78 that describes or references the external service change 76 implemented by the external service 70. Because the external service 70 has changed (such as in response to the event notification 30), the double subscription application 100 may change, adapt, or react by alerting the upstream database system 32. The double subscription application 100 may further cause or instruct the hardware processor 104 to perform operations for sending or forwarding the service change notification 78 to the database system 32 (as explained with reference to FIGS. 1-5). The server 28, though, may generate and send another message or alert to the database system 32. The double subscription application 100, providing at least a portion of the intermediary subscription service 60, thus notifies the database system 32 that the external service 70 changed or modified, in response to nodal/edge/subgraph changes to the graph 38. The double subscription application 100 may further cause or instruct the hardware processor 104 to perform operations for receiving the subsequent event notification (illustrated as reference numeral 30a in FIG. 4) sent by the database system 32 (as explained with reference to FIGS. 1-5). If the database system 32 makes node/edge/subgraph changes in response to the external service change 76, then the database system 32 may generate and send another event notification 30a. This subsequent event notification 30a describes or references the recent or latest updates/changes to the graph 38 associated with the database 36. The double subscription application 100 may thus cause or instruct the hardware processor 104 to perform operations that implement the reactive event notification loop 20 and/or the double subscription service 24.

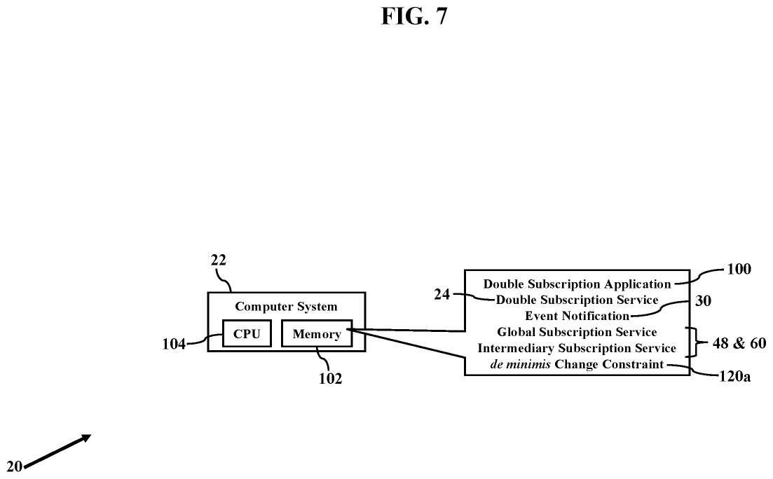

FIGS. 7-9 illustrate examples of pub/sub constraints 120. As the computer system 22 operates, the double subscription application 100 may consult one or more of the pub/sub constraints 120 that may limit the double subscription service 24. Each pub/sub constraint 120 may cause the double subscription application 100 to restrict, to stop/terminate, or to even decline to provide the double subscription service 24. FIG. 7, for example, illustrates a de minimis change constraint 120a. The de minimis change constraint 120a represents or specifies a required minimum change in a node 40, edge 42, or subgraph 44. That is, even though the double subscription application 100 receives the event notification 30 describing a graphical change in the graph 38, that node/edge/subgraph 40/42/44 change must satisfy the de minimis change constraint 120a. So, when the double subscription application 100 receives the event notification 30, the double subscription application 100 may compare the event notification 30 to the de minimis change constraint 120a. The event notification 30, for example, may describe a current and/or a historical/past value/position associated with the node 40, edge 42, and/or subgraph 44. The event notification 30, as another example, may describe an absolute value or magnitude associated with a change in a node 40, edge 42, and/or subgraph 44. The event notification 30, as yet another example, may describe a logical true/false or 0/1 change in the node 40, edge 42, and/or subgraph 44. Whatever the change, the double subscription application 100 may compare the change to the de minimis change constraint 120a. If the node/edge/subgraph change is greater than, exceeds, or otherwise satisfies the de minimis change constraint 120a, then the double subscription application 100 may process the event notification 30 according to the global or outer subscription service 48 and/or the intermediary subscription service 60. The double subscription application 100, for example, may permit or conduct another cycle/loop of the reactive event notification loop 20. If, however, the node/edge/subgraph change is less than, equal to, or otherwise fails to satisfy the de minimis change constraint 120a, then the double subscription application 100 may decline to process the event notification 30. The event notification 30, in other words, describes too small of a change in the graph 38 to warrant or justify the publication time/expense/resources. The double subscription application 100, and/or the double subscription service 24, may thus ignore small graphical changes that do not satisfy the de minimis change constraint 120a. The double subscription application 100, for example, may stop/terminate/halt the double subscription service 24 and/or decline another cycle/loop of the reactive event notification loop 20.

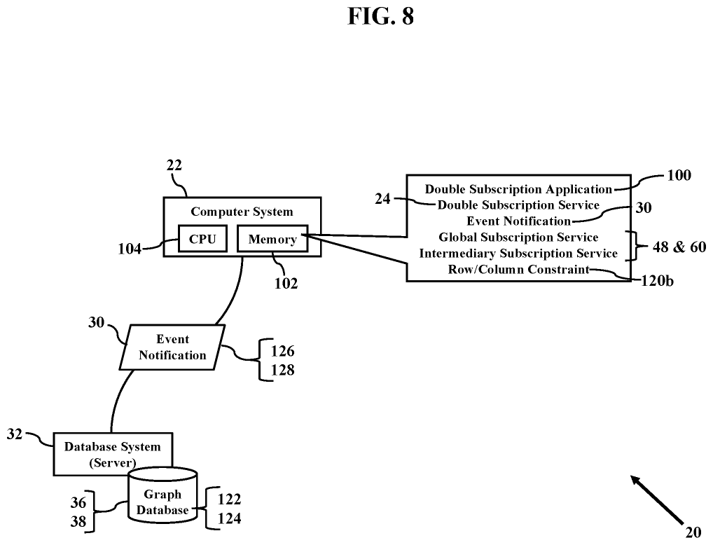

FIG. 8 illustrates a row/column constraint 120b. As the database system 32 traverses the graph 38, the database system 32 may process and modify rows 122 and/or columns 124 within the database 36. Some changes to the database 36, for example, may modify many of the rows 122 and/or columns 124. Other changes to the database 36, though, may only modify a few of the rows 122 and/or columns 124. When the database system 32 sends the event notification 30, the event notification 30 may thus have fields, data, or other content referencing how many of the rows 122 and/or how many of the columns 124 were recently modified. The event notification 30, in other words, may describe modified row change count 126 and/or a modified column change count 128. So, when the double subscription application 100 receives the event notification 30, the double subscription application 100 may compare the modified row change count 126 and/or the modified column change count 128 to the row/column constraint 120b. For example, if the number of changed rows 122 (e.g., the modified row count 126) is greater than, exceeds, or otherwise satisfies the row/column constraint 120b, then the double subscription application 100 may process the event notification 30 according to the global or outer subscription service 48 and/or the intermediary subscription service 60. If, however, the number of changed rows 122 (e.g., the modified row count 126) is less than, equal to, or otherwise fails to satisfy the row/column constraint 120b, then the double subscription application 100 may decline to process the event notification 30. The event notification 30, in other words, describes too small of a row/column change in the graph 38 to warrant or justify the publication time/expense/resources. The double subscription application 100 may similarly compare the number of changed columns 124 (e.g., the modified column count 128) to the row/column constraint 120b. The double subscription application 100, and/or the double subscription service 24, may thus ignore small row/columnar changes that do not satisfy the row/column constraint 120b. The double subscription application 100, and/or the double subscription service 24, may thus approve or deny/terminate additional cycles/loops of the reactive event notification loop 20 based on the row/column constraint 120b.

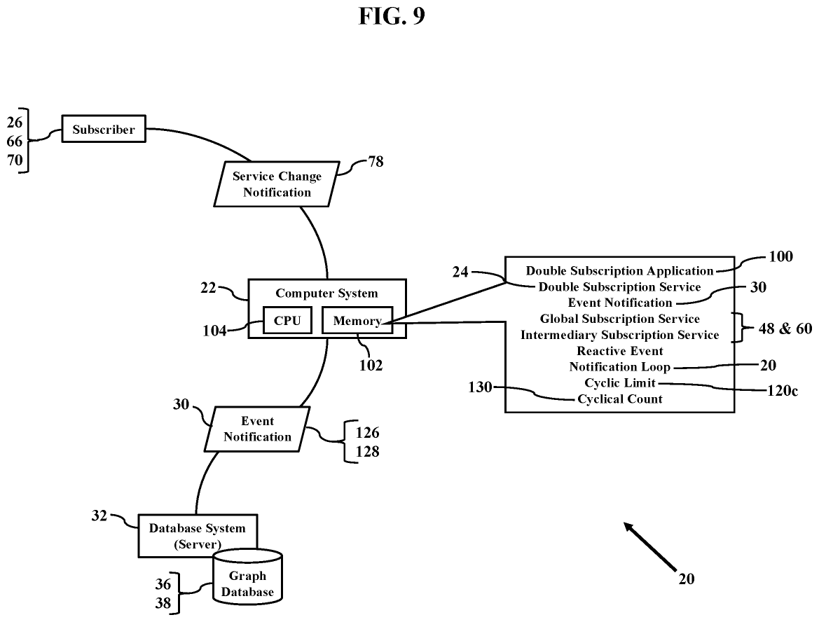

FIG. 9 illustrates a maximum cyclic limit or constraint 120c. The double subscription application 100 brokers and/or implements the reactive event notification loop 20. The double subscription application 100 listens for nodal/edge/subgraph changes to the graph 38, notifies the subscriber(s) 26/66, and then triggers further changes to the graph 38. The reactive event notification loop 20 may thus be circular and keep going/updating as many times as desired (as explained with reference to FIG. 5). Indeed, the double subscription application 100 and/or the reactive event notification loop 20 may recursively update the database/graph 36/38 and/or the external service 70 until no further updates are warranted (such as the change constraints 120a-b, as explained with reference to FIGS. 7-8). As FIG. 9 illustrates, though, the intermediary subscription service 60 may alternatively be configured to only permit the maximum cyclic limit or constraint 120c. That is, the double subscription application 100 may determine a cyclical count 130 associated with the reactive event notification loop 20. The double subscription application 100 may increment the cyclical count 130 with each reactive event notification loop 20. The double subscription application 100, for example, may count the number of event notifications 30 and/or the number of responsive service change notifications 78 that are exchanged or received by the computer system 22 and/or by the intermediary subscription service 60. The double subscription application 100 may then compare the cyclical count 130 to the maximum cyclic limit or count 120c. The maximum cyclic limit or count 120c describes or represents a limit on the number of the reactive event notification loops 20 that are permitted/allowed/requested/completed. If, for example, the cyclical count 130 is less than or equal to the maximum cyclic limit or count 120c, then the intermediary subscription service 60 may receive and/or process another event notification 30 and/or another service change notification 78. The maximum cyclic limit or count 120c, in other words, allows the double subscription application 100 to continue processing recursive updates to the database/graph 36/38 and/or to the service 70. If, however, the cyclical count 130 exceeds the maximum cyclic limit or count 120c, then the intermediary subscription service 60 and/or the reactive event notification loop 20 has reached its limit. The double subscription application 100, for example, may not receive nor process additional event notifications 30 and/or service change notifications 78. The double subscription application 100, and/or the intermediary subscription service 60, may ignore further changes to the database/graph 36/38 and/or to the service 70. The double subscription application 100, and/or the double subscription service 24, may thus approve or deny/terminate additional cycles/loops of the reactive event notification loop 20 based on the maximum cyclic limit or count 120c. The maximum cyclic limit or count 120c, in other words, limits time, money/costs, and hardware and/or software resources devoted to recursive database updates.

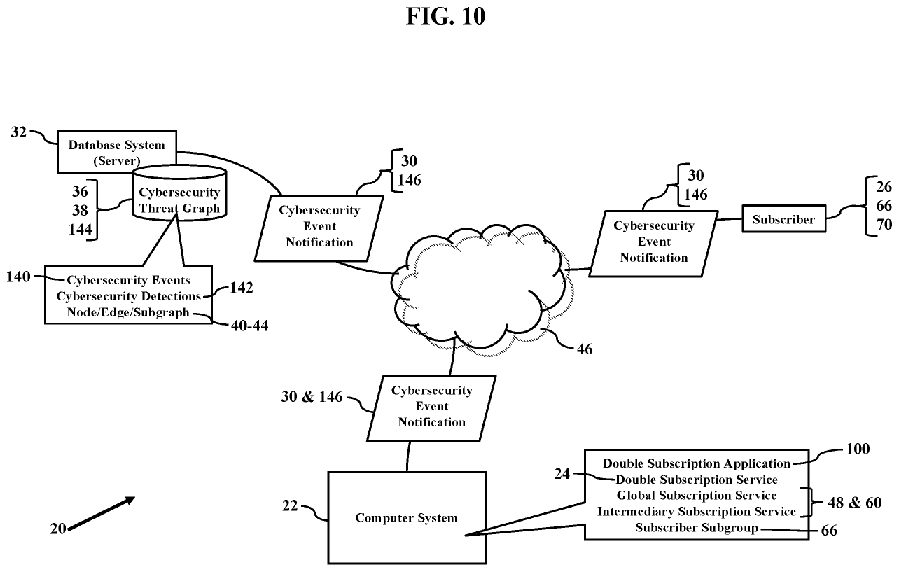

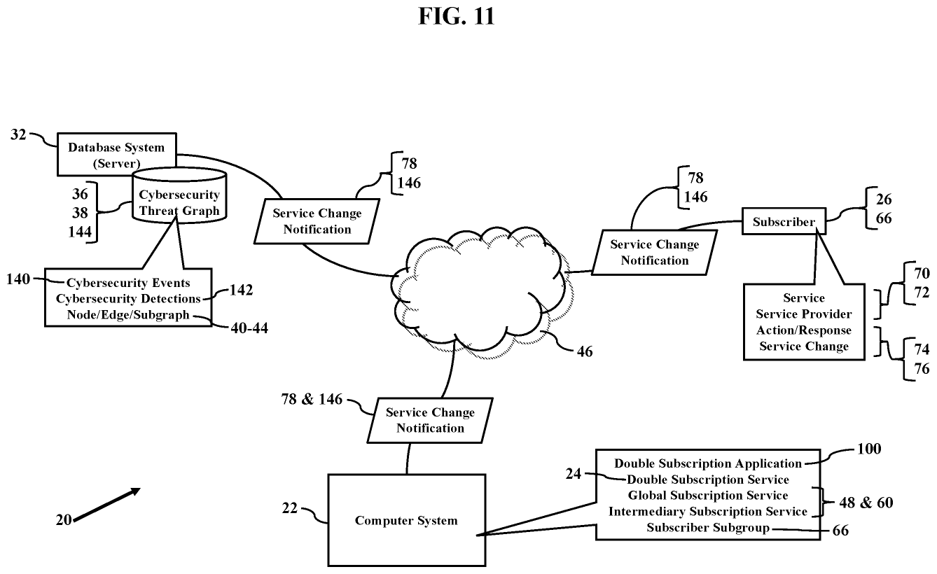

FIGS. 10-11 illustrate still more detailed examples of the reactive event notification loop 20. The double subscription service 24 may notify the external subscriber/service 26/70 of cybersecurity events 140 logged/stored by the database system 32. While the database system 32 may store any electronic data 34, here the database 36 may store and log hardware and software cybersecurity events 140 associated with cybersecurity detections 142. That is, the cybersecurity events 140 and/or the cybersecurity detections 142 may be collected from endpoint cybersecurity detection agents operating in endpoint client devices (not shown for simplicity). Each endpoint cybersecurity detection agent provides a cybersecurity service that detects suspicious client activity, malware, and other cybersecurity attacks. The endpoint cybersecurity detection agents compare event streams, kernel events, user-mode events, process creation events, messages, and/or other software/hardware activities to cybersecurity signatures and profiles. If the client's activities match or satisfy a suspicious/malicious signature/pattern/profile, then the endpoint cybersecurity detection agent reports the cybersecurity events 140 as the cybersecurity detections 142 to the database system 32. The database system 32 logs and stores the cybersecurity events/detections 140/142 as new or updated entries in the database 36. The database system 32 may also plot, map, or graph the cybersecurity events/detections 140/142 to the graph 38. Here, though, the graph 38 may be a cybersecurity threat graph (illustrated as reference numeral 144) that maps or diagrams relationships between the cybersecurity events 140 and/or the cybersecurity detections 142. When the cybersecurity threat graph 144 changes, the database system 32 may thus generate and send a cybersecurity-version of the event notification 30 (illustrated as a cybersecurity event notification 146). The cybersecurity event notification 146 describes or references the graphical change (e.g., the node 40, edge 42, and/or subgraph 44) to the cybersecurity threat graph 144 caused by the cybersecurity events/detections 140/142.

The double subscription service 24 may thus alert the external subscribers 26. The double subscription application 100, for example, causes or instructs the computer system 22 to receive the cybersecurity event notification 146 associated with the cybersecurity threat graph 144. The double subscription application 100 may further cause or instruct the computer system 22 to provide the global or outer subscription service 48 that distributes or publishes the cybersecurity event notification 146 to all the subscribers 26 associated with the cybersecurity threat graph 144. The double subscription application 100 further causes or instructs the computer system 22 to provide the intermediary subscription service 60 that forwards or publishes the cybersecurity event notification 146 to the subscriber subgroup 66. The subscriber subgroup 66, in particular, has registered their subscriptive interest in the node/edge/subgraph portion of the cybersecurity threat graph 144. The intermediary subscription service 60 thus asynchronously alerts the subscriber subgroup 66 that their specific portion of the cybersecurity threat graph 144 has changed due to the cybersecurity events/detections 140/142.

As FIG. 11 illustrates, the double subscription service 24 also enables the reactive event notification loop 20. When the subscriber 26/66 changes or modifies its service 70, the double subscription application 100 may cause or instruct the computer system 22 to receive the service change notification 78 that describes or references the service change 76 implemented by the service 70. Because the service 70 has changed (such as in response to the cybersecurity event notification 146 illustrated in FIG. 10), the double subscription application 100 programs the computer system 22 to react by alerting the upstream database system 32. The double subscription application 100 may cause or instruct the computer system 22 to anonymize the service change notification 78 (e.g., remove or delete identity and network address information) and send the anonymized service change notification 78 to the database system 32. The double subscription application 100, providing at least a portion of the intermediary subscription service 60, thus notifies the database system 32 that the service 70 changed or modified. The reactive event notification loop 20, as previously explained, may drive additional or subsequent updates to the cybersecurity threat graph 144. The database system 32 may thus generate and send another/subsequent cybersecurity event notification 146 (as above explained), thus causing the double subscription application 100 to perform yet another cycle of the reactive event notification loop 20 (and, for example, incrementing the cyclical count 130 as explained with reference to FIG. 9). The double subscription application 100 may continue publishing and reacting, perhaps until termination due to the loopal constraint 120.

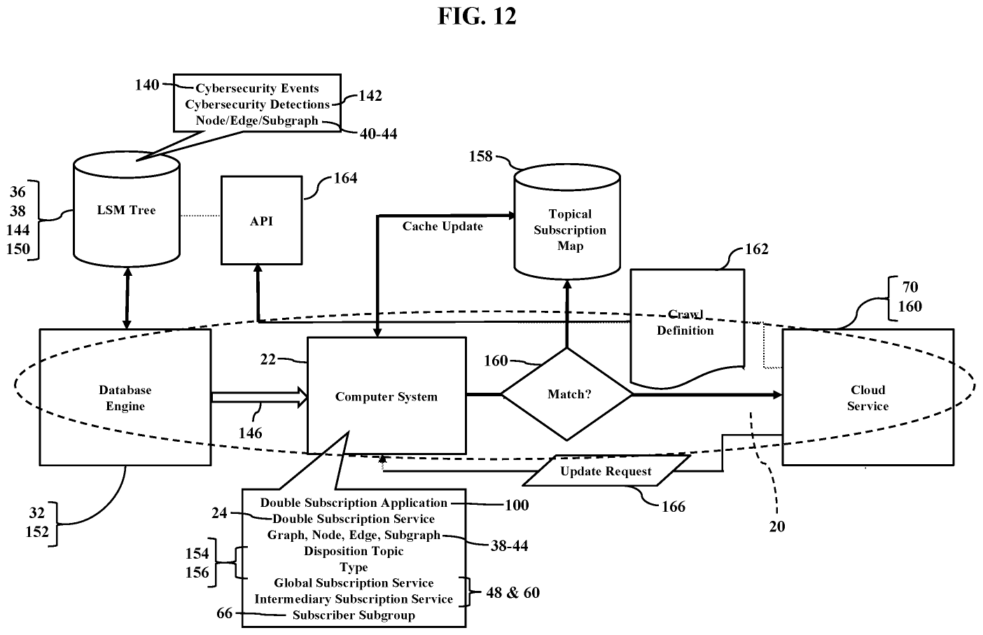

FIG. 12 illustrates a flowchart or method for publishing the cybersecurity event notification 146. Cybersecurity service providers may process trillions of the cybersecurity events 140 and/or the cybersecurity detections 142 in a single day. The database system 32 may thus be scaled to store many petabytes per day. While the database system 32 may implement a database storage scheme, FIG. 12 illustrates the cybersecurity threat graph 144 implementing a log-structured merge (or LSM) tree 150 (such as the APACHE CASSANDRA® database management system). The database system 32 may thus have a computer/server database engine 152 that writes/reads/appends the cybersecurity events 140 and/or the cybersecurity detections 142 to the cybersecurity threat graph 144. When the database engine 152 changes/modifies/updates the cybersecurity threat graph 144, the database engine 152 issues the cybersecurity event notification 146 addressed to the computer system 22 providing the double subscription service 24. The cybersecurity event notification 146 may specify different identifiers that correspond to the node/edge/subgraph 40/42/44 changed within the cybersecurity threat graph 144. The cybersecurity event notification 146, in particular, may specify a disposition topic 154 for relevant nodal/edge/subgraph type(s) 156.

The double subscription service 24 alerts the external subscribers 26. When the computer system 22 receives the cybersecurity event notification 146, the double subscription application 100 instructs the computer system 22 to provide the global or outer subscription service 48 that distributes or publishes the cybersecurity event notification 146 to all the external subscribers 26 associated with the cybersecurity threat graph 144. The double subscription application 100 also instructs the server 28 to provide the intermediary subscription service 60 that forwards or publishes the cybersecurity event notification 146 to the subscriber subgroup 66. The double subscription application 100 may thus ingest or consume all cybersecurity event notifications 146 of all relevant disposition topics 154 associated with the cybersecurity threat graph 144. The double subscription application 100 may then compare the disposition topic 154 to a topical subscription map 158. The topical subscription map 158 relates or associates different subscriber subgroups 66 to their corresponding subscriptive topics 154 and/or subscriptive node/edge/subgraph 40/42/44. The double subscription application 100 may query the topical subscription map 158 for the topic 154 and/or for the node/edge/subgraph 40/42/44 and identify/retrieve the corresponding subscriber subgroup 66. The intermediary subscription service 60 may then notify the subscriber subgroup 66 of the topic/nodal/edge/subgraph 154/40/42/44 that changed (as described by the cybersecurity event notifications 146). For example, if the cybersecurity event notification 146 specifies or references a new/unknown disposition topic 154, then the double subscription application 100 may perform a vertex identifier check for a nodal/edge/subgraph ID associated with the subscribers 26. If the nodal/edge/subgraph ID does not exist in, or fails to matched to, the topical subscription map 158 (Block 160), then the double subscription application 100 and/or the intermediary subscription service 60 may update the topical subscription map 158 (such as by adding a new entry associated with the nodal/edge/subgraph ID). If, however, the nodal/edge/subgraph ID exists in, or is matched to, the topical subscription mapping (Block 160), then the double subscription application 100 may instruct the computer system 22 to send the cybersecurity event notification 146 (such as the disposition topic 154) to the external/internal service 70. While the double subscription service 24 may interface with the service 70, FIG. 12 illustrates the service 70 as a cloud service 160. The cloud service 160 represents an internal/external service 70 that reacts to changes/modifications/updates at the database system 32 (such as the cybersecurity threat graph 144). The cloud service 160 may then request a cybersecurity threat graph crawl by sending a crawl definition (Block 162) using an appropriate application programming interface (or API) (Block 164). The external service 70 (perhaps again the cloud service 160) may also update the intermediary subscription service 60 by sending an update request (perhaps using the appropriate API) specifying or referencing a root vertex ID and crawled nodal/edge/subgraph ID (Block 166).

Computer functioning is greatly improved. The double subscription service 24, and the reactive event notification loop 20, greatly improves the computer functioning of the computer system 22. The double subscription service 24, and the reactive event notification loop 20, allows the computer system 22 to process and to store massive amounts (petabytes representing trillions) of daily cybersecurity events/detections 140/142 that are reported by clients. The double subscription service 24, and the reactive event notification loop 20, allow the computer system 22 to far more efficiently utilize the byte capacity of the memory device 102 and the processing power of the hardware processor 104. Moreover, the double subscription service 24, and the reactive event notification loop 20, allow the computer system 22 to much more quickly detect the events/detections 140/142 representing malicious usage and/or cybersecurity attacks. The double subscription service 24, and the reactive event notification loop 20, thus allow the computer system 22 to block/stop/halt the events/detections 140/142 to prevent degraded computer performance, network intrusion, stolen data, or other cybersecurity attack.

Even more computer functioning is greatly improved. The double subscription service 24, and the reactive event notification loop 20, thus allow the computer system 22 to define the nodal/edge/subgraph subscriptive watchers. The subscriptions may be specified using both specific crawl paths (such as the crawl definition illustrated as Block 162) as well as metadata specifying reactive responses to graphical changes (e.g., topic/nodal/edge/subgraph 154/40/42/44). The double subscription service 24, and the reactive event notification loop 20, allow the computer system 22 to notify both upstream and downstream parties of graphical changes (even entities) of interest. The event notifications 30 may describe a mutation (e.g., node/edge/subgraph mutation disposition) to the graph 38. Indeed, because the double subscription service 24, and the reactive event notification loop 20, may notify of subgraph changes, the computer system 22 need not re-crawl the graph 38 on regular intervals to get the most up-to-date graph information. The double subscription service 24, and the reactive event notification loop 20, thus reduce hardware and software operations, reduce network traffic, and reduce electrical power consumption. The double subscription service 24, and the reactive event notification loop 20, cause the computer system 22 to listen for event notifications 30 referencing regular mutation disposition events. The computer system 22 may match each of one of them against its internal state to determine if an external subscriber 26 should be notified.

Still more computer functioning is greatly improved. The double subscription service 24, and the reactive event notification loop 20, allow the computer system 22 to detect changes to disjoint graphs 38. Suppose, for example, the double subscription application 100 instructs the computer system 22 to watch for a node 40 (or vertex V) and all of its edges 42 of type T. At the time of creating the watcher, if there no instances of T, the computer system 22 should still be able to detect new edges 42 that will be connected to V. The computer system 22 may also retain configurational settings, such as optionally renewing expired watchers after some time to live. The computer system 22 may also monitor wildcard edges 42 (specified as any edge 42 of type T connected to vertex V) and automatically watch all instances of that edge 42 up to some traversal depth. The computer system 22 may also have throttling configurations that allow users to set the rate limit at which the event notifications 30 will be produced. Watcher definitions will be completely dynamic and will be added at runtime via REST requests. These functional configurations enhance computer performance, reduce network traffic, and reduce electrical power consumption.

Yet more computer functioning is greatly improved. The double subscription service 24, and the reactive event notification loop 20, have very little hardware/software overhead. The event notifications 30 are emitted at a massive scale, so the computer system 22 ingesting them must take proper measures to ensure resilience and stability. The computer system 22, for example, may need to perform a subscriptive lookup for every ingested event notification 30. While this can be optimized by using local caches and utilizing node affinity (as FIG. 12 illustrates), subscriptive lookups may still be a considerable amount of network traffic to handle. Other than that subscriptive lookup check, the double subscription service 24, and the reactive event notification loop 20, have relatively low overhead. Moreover, highly-connected entities may result in the graphical watchers being too verbose. That is, any updates to these vertices may trigger dozens of watchers. The double subscription service 24, and the reactive event notification loop 20, may thus collapse the triggers by namespace and then Group ID.

Even more computer functioning is greatly improved. The graph 38 need not be crawled multiple times on regular intervals. Graphical crawling requires intensive hardware and software operations. Yet, by only monitoring for node/edge/subgraph changes, resources and electrical power are reduced for each unneeded crawl. Any external subscriber 26 may subscribe to an individual node/vertex 40, its edge 42, and/or its subgraph 44. The double subscription service 24, and the reactive event notification loop 20, will then listen to the incoming event notifications 30 (e.g., change dispositions), check to see if that node/vertex 40 exists in the cache of subscriber vertices, and, if so, safely assume that a re-crawl of that subgraph would result in updated data. This allows the database system 32, and/or the computer system 22, to only crawl the subgraphs 44 when needed, as the double subscription application 100 confidently knows that the state of the subgraph 44 has changed. The double subscription service 24, and the reactive event notification loop 20, thus allow a new way of monitoring the extensive and constantly changing data points that make up the graph 38 (such as the cybersecurity threat graph 144). The double subscription application 100 may thus alert of a graphical change associated with an individual entity, but the double subscription application 100 may utilize the event notifications 30 to create a far more efficient system of updating interested parties of graphical changes of interest.

The double subscription service 24, and the reactive event notification loop 20, may be offered as cloud services. A cloud computing environment/network may have networked members (such as the computer system 22) that provide the double subscription service 24. The cloud computing environment/network may also provide the intermediary subscription service 60 that implements the reactive event notification loop 20 as an infrastructure middle broker between the database system 32 and the subscriber 26. A cloud service provider (such as the cybersecurity service provider) may thus offer the double subscription service 24, and the intermediary subscription service 60, as enablers of the reactive event notification loop 20.

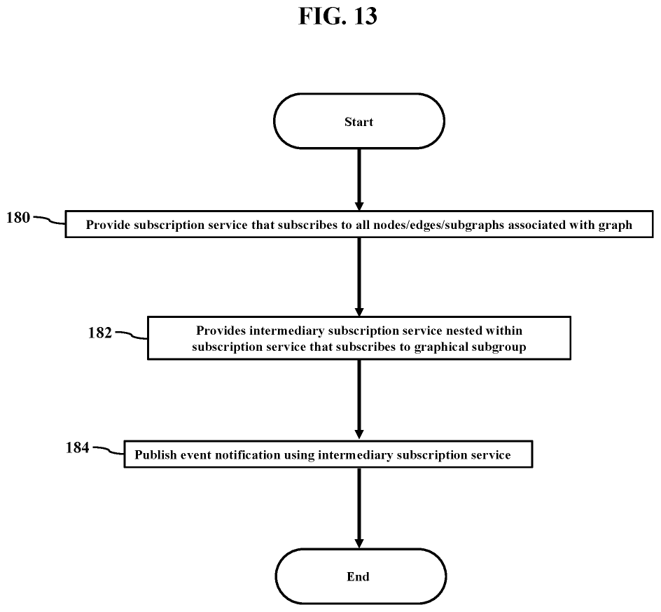

FIG. 13 illustrates more examples of a flowchart or method for publishing the event notification 30. The computer system 22 provides the outer subscription service 48 that subscribes to all the graphical nodes/edges/subgraphs 40-44 associated with the graph 38 (Block 180). The computer system 22 provides the intermediary subscription service 60 nested within the outer subscription service 48 that subscribes to the graphical subgroup 62 of the graphical nodes/edges/subgraphs 40-44 associated with the graph 38 (Block 182). The computer system 22 publishes the event notification 30 using the intermediary subscription service 60 nested within the outer subscription service 48 (Block 184).

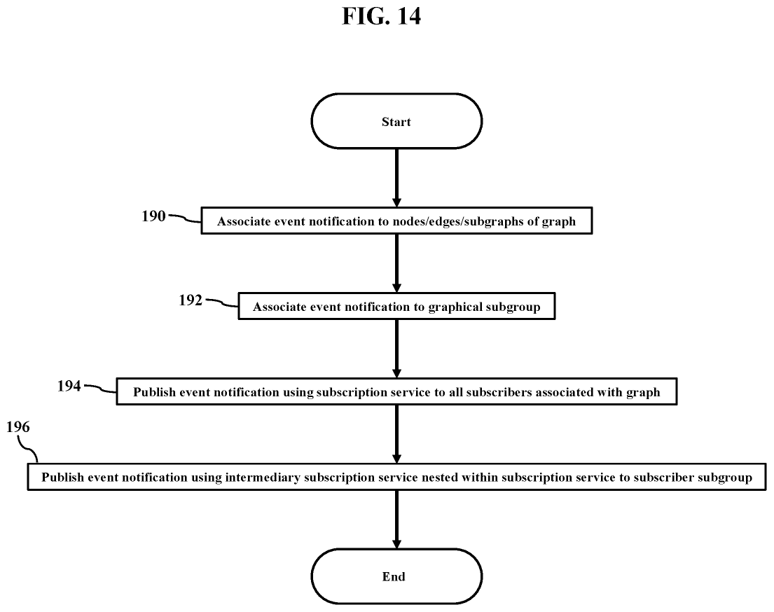

FIG. 14 illustrates still more examples of a flowchart or method for publishing the event notification 30. The event notification is associated to the nodes/edges/subgraphs 40-44 of the graph 38 (Block 190). The event notification is associated to the graphical subgroup 62 (Block 192). The event notification 30 is published using the outer subscription service 48 to all the subscribers 26 associated with the graph 38 (Block 194). The event notification 30 is published using the intermediary subscription service 60 nested within the outer subscription service 48 to the subscriber subgroup 66 of the subscribers 26 associated with the graphical subgroup 62 (Block 196).

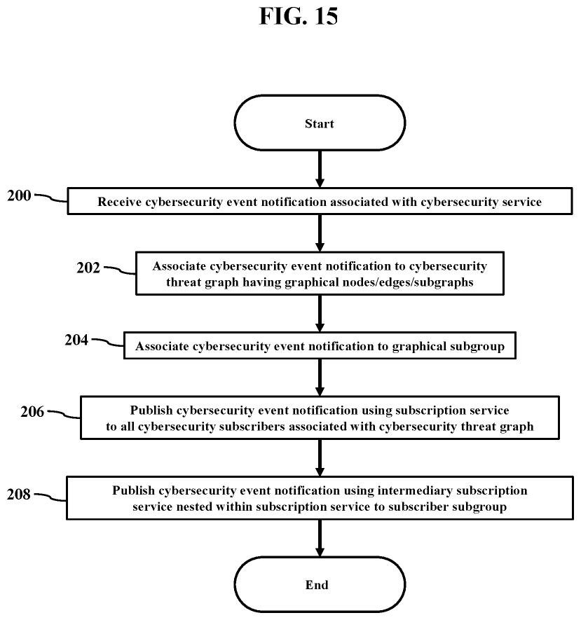

FIG. 15 illustrates examples of a flowchart or method for publishing the cybersecurity event notification 146. The cybersecurity event notification 146, associated with a cybersecurity service, is received (Block 200). The cybersecurity event notification 146 is associated to the cybersecurity threat graph 144 having the graphical nodes/edges/subgraphs 40-44 (Block 202). The cybersecurity event notification 146 is associated to the graphical subgroup 62 (Block 204). The cybersecurity event notification 146 is published using the outer subscription service 48 to all the cybersecurity subscribers 26 associated with the cybersecurity threat graph 144 (Block 206). The cybersecurity event notification 146 is published using the intermediary subscription service 60 nested within the outer subscription service 48 to the subscriber subgroup 66 associated with the graphical subgroup 62 (Block 208).

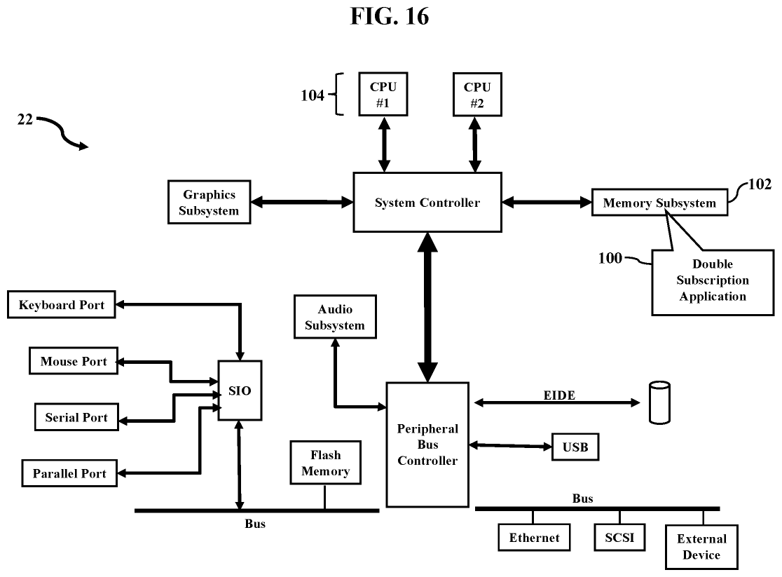

FIG. 16 illustrates a more detailed example of the operating environment. FIG. 16 is a more detailed block diagram illustrating the computer system 22 (such as the server 28). The double subscription application 100 is stored in the memory subsystem or device 102. One or more of the hardware processors 104 communicate with the memory subsystem or device 102 and execute the double subscription application 100. Examples of the memory subsystem or device 102 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology. Because the computer system 22 is known to those of ordinary skill in the art, no detailed explanation is needed.

The computer system 22 may have any embodiment. This disclosure mostly discusses the computer system 22 as the server 28. The double subscription service 24, and the double subscription application 100, however, may be easily adapted to any stationary or mobile computing device that executes code, wherein the computer system 22 may be a mobile smartphone, a tablet computer, a smartwatch, and a network switch/router. The double subscription service 24, and the double subscription application 100, may also be easily adapted to other embodiments of smart devices, such as a television, an audio device, a remote control, and a recorder. The double subscription service 24, and the double subscription application 100, may also be easily adapted to still more smart appliances, such as washers, dryers, and refrigerators. Indeed, as cars, trucks, and other vehicles grow in electronic usage and in processing power, the double subscription service 24, and the double subscription application 100, may be easily incorporated into any vehicular controller.

The double subscription service 24, and the double subscription application 100, may be applied regardless of the networking environment. The double subscription service 24, and the double subscription application 100, may be easily adapted to stationary or mobile devices having wide-area networking (e.g., 4G/LTE/5G cellular), wireless local area networking (WI-FI®), near field, and/or BLUETOOTH® capability. The double subscription service 24, and the double subscription application 100, may be applied to stationary or mobile devices utilizing any portion of the electromagnetic spectrum and any signaling standard (such as the IEEE 802 family of standards, GSM/CDMA/TDMA or any cellular standard, and/or the ISM band). The double subscription service 24, and the double subscription application 100, however, may be applied to any processor-controlled device operating in the radio-frequency domain and/or the Internet Protocol (IP) domain. The double subscription service 24, and the double subscription application 100, may be applied to any processor-controlled device utilizing a distributed computing network, such as the Internet (sometimes alternatively known as the “World Wide Web”), an intranet, a local-area network (LAN), and/or a wide-area network (WAN). The double subscription service 24, and the double subscription application 100, may be applied to any processor-controlled device utilizing power line technologies, in which signals are communicated via electrical wiring. Indeed, the many examples may be applied regardless of physical componentry, physical configuration, or communications standard(s).

The computer system 22 may utilize any processing component, configuration, or system. For example, the double subscription service 24, and the double subscription application 100, may be easily adapted to any desktop, mobile, or server central processing unit or chipset offered by INTEL®, ADVANCED MICRO DEVICES®, ARM®, APPLE®, TAIWAN SEMICONDUCTOR MANUFACTURING®, QUALCOMM®, or any other manufacturer. The computer system 22 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

The double subscription service 24, and the double subscription application 100, may use packetized communications. When the computer system 22 communicates via the communications network 46, information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The double subscription service 24, and the double subscription application 100, may utilize any signaling standard. The computer system 22, the communications network 46, and/or a cloud-computing environment/network may mostly use wired networks to interconnect network members. However, the computer system 22, the communications network 46, and/or a cloud-computing environment/network may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. The double subscription service 24, and the double subscription application 100, may also utilize other standards, such as the I.E.E.E. 802 family of standards, the Industrial, Scientific, and Medical band of the electromagnetic spectrum, BLUETOOTH®, low-power or near-field, and any other standard or value.

The double subscription service 24, and the double subscription application 100, may be physically embodied on or in a computer-readable storage medium. This computer-readable medium, for example, may include CD-ROM, DVD, tape, cassette, floppy disk, optical disk, USB flash memory drive, memory card, memory drive, and large-capacity disks. This computer-readable medium, or media, could be distributed to end-subscribers, licensees, and assignees. A computer program product comprises processor-executable instructions for publishing the event notification 30, as the above paragraphs explain.

The diagrams, schematics, illustrations, and the like represent conceptual views or processes illustrating examples of cloud services malware detection. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system that publishes an event notification, comprising:
providing, by the computer system, a subscription service that subscribes to all graphical nodes associated with a graph;
providing, by the computer system, an intermediary subscription service nested within the subscription service that subscribes to a subgroup of the graphical nodes associated with the graph; and
publishing, by the computer system, the event notification using the intermediary subscription service nested within the subscription service.

2. The method of claim 1, further comprising publishing the event notification to all subscribers associated with the graph.

3. The method of claim 1, further comprising publishing the event notification to a subscriber associated with the subgroup using the intermediary subscription service.

4. The method of claim 1, further comprising publishing the event notification to subscribers associated with the graph using both the subscription service and the intermediary subscription service.

5. The method of claim 1, further comprising cyclically updating the graph using the intermediary subscription service.

6. The method of claim 1, further comprising comparing the event notification to a constraint associated with the intermediary subscription service.

7. The method of claim 1, further comprising terminating the intermediary subscription service in response to a constraint.

8. At least one computer system that publishes an event notification, comprising:
at least one central processing unit; and
at least one memory device storing instructions that, when executed by the at least one central processing unit, perform operations, the operations comprising:
associating the event notification to a graph having nodes;
associating the event notification to a subgroup of the nodes;
publishing the event notification using a subscription service to all subscribers associated with the graph; and
publishing the event notification using an intermediary subscription service nested within the subscription service to a subscriber subgroup of the subscribers associated with the subgroup of the nodes.

9. The at least one computer system of claim 8, wherein the operations further comprise cyclically updating the graph using the intermediary subscription service.

10. The at least one computer system of claim 8, wherein the operations further comprise cyclically updating the graph via a reactive event notification loop.

11. The at least one computer system of claim 8, wherein the operations further comprise comparing the event notification to a constraint associated with the intermediary subscription service.

12. The at least one computer system of claim 11, wherein the operations further comprise determining the event notification satisfies the constraint associated with the intermediary subscription service.

13. The at least one computer system of claim 12, wherein in response to the determining that the event notification satisfies the constraint associated with the intermediary subscription service, the operations further comprise ending the intermediary subscription service.

14. The at least one computer system of claim 12, wherein in response to the determining that the event notification satisfies the constraint associated with the intermediary subscription service, the operations further comprise terminating a reactive event notification loop.

15. A memory device storing instructions that, when executed by a central processing unit, perform operations, comprising:
receiving a cybersecurity event notification associated with a cybersecurity service;
associating the cybersecurity event notification to a cybersecurity threat graph having nodes;
associating the cybersecurity event notification to a subgroup of the nodes;
publishing the cybersecurity event notification using a subscription service to all cybersecurity subscribers associated with the cybersecurity threat graph; and
publishing the cybersecurity event notification using an intermediary subscription service nested within the subscription service to a subscriber subgroup of the cybersecurity subscribers associated with the subgroup of the nodes.

16. The memory device of claim 15, wherein the operations further comprise cyclically updating the cybersecurity threat graph using the intermediary subscription service nested within the subscription service.

17. The memory device of claim 15, wherein the operations further comprise cyclically updating the cybersecurity threat graph via a reactive event notification loop.

18. The memory device of claim 15, wherein the operations further comprise comparing the cybersecurity event notification to constraint associated with the intermediary subscription service.

19. The memory device of claim 18, wherein the operations further comprise determining the cybersecurity event notification satisfies the constraint associated with the intermediary subscription service.

20. The memory device of claim 18, wherein the operations further comprise:
determining that the cybersecurity event notification fails to satisfy the constraint associated with the intermediary subscription service; and
declining to publish the cybersecurity event notification using the intermediary subscription service.
